(19) United States
(12) Patent Application Publication
(10) Pub. No.: US 2005/0051513 A1
(43) Pub. Date: Mar. 10, 2005

(54) METHOD OF FORMING A LANDING ZONE FOR MAGNETIC RECORDING MEDIA

(76) Inventors: Cheng-Sung Wei, Tao-Yuan Hsien (TW); An-Hung Tan, Tao-Yuan Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,052

(22) Filed: Sep. 5, 2003

(51) Int. Cl. B44C 1/22

(52) U.S. Cl. 216/22

(57) ABSTRACT

A method for forming a disk of a disk drive having a magnetic head for reading data from or writing data to the disk is introduced. The disk is formed of a disk substrate. Additionally, a laser process using a pulse laser with a pulse width of 20˜90 ns and an energy of 0.5˜6.0 μj is performed to form a plurality of rimless depressions in an inner diameter zone having a radius between 0.65″ and 0.78″ of the disk substrate, so that a landing zone is formed for landing the slider.

### BACKGROUND OF INVENTION

1. Field of the Invention

The present invention relates to a method of forming a landing zone for magnetic recording media, and more specifically, to a method of forming a disk of a disk drive capable of reducing friction/stiction between a slider and a surface of the disk.

2. Description of the Prior Art

Disk drives utilize rigid discs coated with a magnetizable medium for storage of digital information in a plurality of concentric data tracks and are widely used in the computer industry.

Referring to FIG. 1. FIG. 1 is a schematic diagram of a typical disk drive. As shown in FIG. 1, the disk drive 10 comprises a housing 12, a plurality of disks 20 rotationally coupled to the housing 12 via a spindle motor 11, and an actuator assembly 14 having an actuator block 16 rotationally coupled to the housing 12 and a voice coil motor (not shown) for driving the actuator block 16 to rotate along the double arrow AA″. The actuator block 16 includes a plurality of actuator arms 16a and a plurality of suspension assembly 16b.Each of the suspension assembly 16b is coupled to an actuator arm 16a for rotationally supporting a slider 18 that is used for reading data from or writing data to the disk 20. Additionally, each of the disks 20 includes a landing zone 20a for parking the slider 18 and a data zone 20b for storing the data.

The slider 18 has an air-bearing surface that faces a surface of the disk 20. As the disk 20 rotates along an arrow BB″, the disk 20 drags air onto the slider 18 along the air-bearing surface so that the pressure between the disk 20 and the air-bearing surface increases, which creates a hydrodynamic lifting force that causes the slider 18 to fly above the surface of the disk 20 to read data from or write data to the disk 20.

Prior to rotation of the disk 20, the slider 18 rests on the landing zone 20a of the disk 20. The slider 18 is not lifted from the disk 20 until the hydrodynamic lifting force, caused by rotation of the disk 20, is sufficient to overcome a preload force supplied to bias the slider 18 toward the surface of the disk 20. The preload force comes from the suspension assembly 16b, while a stiction is a combination of friction and stickiness that causes the slider 18 to adhere to the surface of the disk 20, making it harder for the slider 18 to initiate movement therefrom. Typically, the high friction/stiction occurs when the surface of the disk 20 is too smooth, so that the landing zone 20a of the disk 20 are usually textured to provide a roughened surface for reducing a contact area between the slider 18 and the landing zone 20a, thereby reducing the friction/stiction and facilitating the take-off of the slider 18.

FIG. 2 illustrates a prior art disk with a laser-textured landing zone and a slider parked on the landing zone. As shown in FIG. 2, the slider 18 formed of a rigid member includes a leading edge 18a, a trailing edge 18b, an upper surface 18c connected to the suspension assembly 16b shown in FIG. 1, an air-bearing surface 18d facing the surface of the disk 20 and having a plurality of pads 19a and a center rail 19b, and a transducer (or magnetic head) 21 for reading or writing operations. The disk 20 comprises an aluminum substrate 22, a nickel-phosphorus layer 24 formed on the aluminum substrate 22,a magnetic layer (not shown) formed on the nickel-phosphorus layer 24, an overcoat layer 26 formed on the magnetic layer and a lubricant layer 28 coated over the overcoat layer 26. For reducing the above-mentioned friction/stiction, a plurality of rims 30b is formed in the nickel-phosphorus layer 24 and the rims (or bump) 30b is elevated above a surface 30c of the data zone 20b,and each of the rims surrounds a hole 30a. Furthermore, each of the holes 30a and its corresponding rim 30b are simultaneously formed by a laser technique. Generally, a height of the rims 30b is larger than 60 Å, while a depth of the holes 30a is larger than 200 Å. Additionally, for a disk having a higher storage density in the future, the height of the rims 30b is between 0 Å and 40 Å.

It is noticeable that the current trend in a disk is to store more data in less space, which needs to reduce a flying height of the slider 18. However, when the slider 18 flies above the surface of the disk 20 to read data from or write data to the disk 20, the slider 18 must fly higher than a height of the rims 30b to avoid contacting with the rims 30b, and a storage density of the disk 20 is therefore limited. Additionally, the rims 30b may interfere with the slider 18 at lower flying heights and increase the glide avalanche dimension. Furthermore, as the slider 18 continually contacts with the landing zone 20a, it may take away some lubricant from the rims 30b so that the lubricant on the rims 30b becomes less and less, which increases friction/stiction and decreases wear durability at the interface between the surface of the disk 20 and the air-bearing surface 18d.

Moreover, a smooth disk is also available for high storage density disks. A method of forming the smooth disk is similar to that of forming a data zone for magnetic recording media without any laser process, and the friction/stiction of the smooth disk is controlled through roughening a surface of the smooth disk, but there is a high friction/stiction issue.

### SUMMARY OF INVENTION

It is therefore a primary objective of the claimed invention to provide a method of forming a disk of a disk drive to solve the above-mentioned problem.

According to the claimed invention, a method for forming a disk of a disk drive having a magnetic head for reading data from or writing data to the disk is provided. Firstly, a disk substrate is provided. Then, a laser process using a pulse laser with a pulse width of 20˜90 ns and an energy of 0.5˜6.0 μJ for forming a plurality of rimless depressions in an inner diameter zone having a radius between 0.65″ and 0.78″ of the disk substrate is performed, so that a landing zone is formed.

It is an advantage over the prior art that the claimed invention utilizes the pulse laser with a pulse width of 20˜90 ns and an energy of 0.5˜6.0 μJ to form a plurality of rimless depressions in the landing zone. Due to the rimless depressions, the friction/stiction and the tipping issue are reduced, while the life of the slider and the disk are extended. Furthermore, the claimed invention also increases a capability of the storage density of the disk, decreases the glide avalanche dimension, and decreases head degradation.

These and other objectives of the present invention will no doubt become obvious to those of ordinary skill in the art after reading the following detailed description of the preferred embodiment, which is illustrated in the multiple figures and drawings.

### BRIEF DESCRIPTION OF DRAWINGS

FIG. 1 is a schematic diagram of a typical disk drive.

FIG. 2 illustrates a prior art disk with a laser-textured landing zone and a slider parked on the landing zone.

FIG. 3 and FIG. 4 are schematic diagrams of forming a disk 40 having a landing zone 40a and a data zone 40b according to the present invention.

FIG. 5 illustrates the relationship between a height of a rim and energy of a pulse laser.

FIG. 6 illustrates the relationship between the pulse width and the energy of the pulse laser for rim height.

FIG. 7 illustrates a disk and a slider parked on a landing zone of the disk according to the present invention.

FIG. 8 illustrates the relationship between a stiction and a height of a rim.

### DETAILED DESCRIPTION

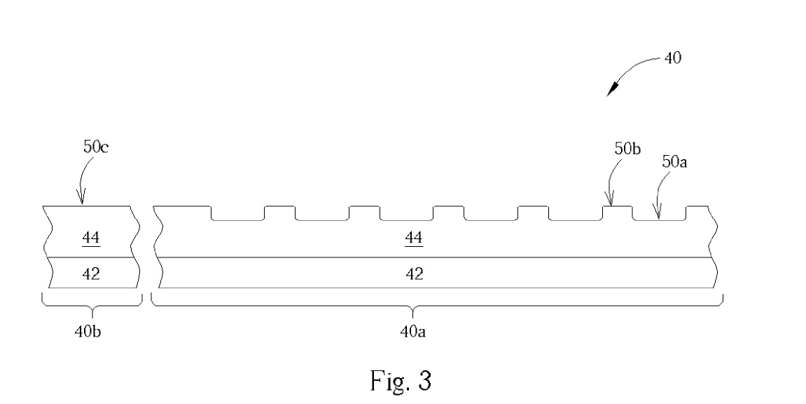

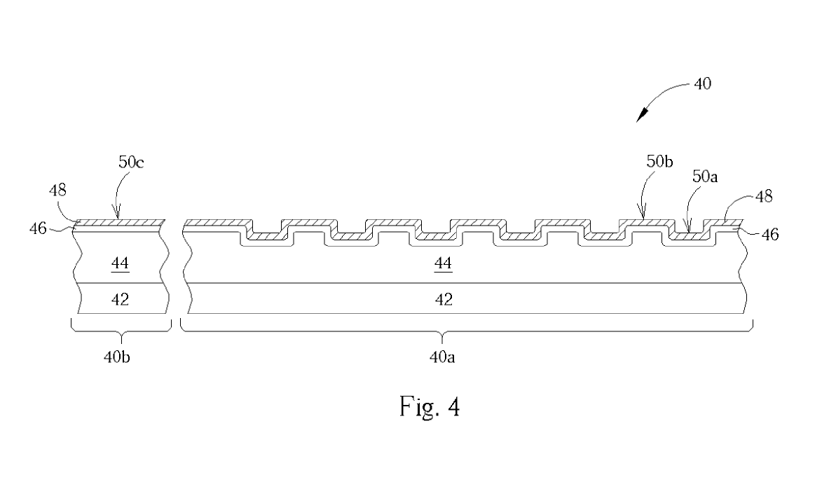

Referring to FIG. 3 and FIG. 4. FIG. 3 and FIG. 4 are schematic diagrams of forming a disk 40 having a landing zone 40a and a data zone 40b according to the present invention. As shown in FIG. 3, a substrate 42 formed of an aluminum material is provided and a nickel-phosphorus (NiP) plating layer 44 is deposited on the substrate 42. Thereafter, a laser process is performed to form a plurality of rimless depressions 50a in the nickel-phosphorus plating layer 44 in an inner diameter zone having a radius between 0.65″ and 0.78″ of the substrate 42. Therefore, a landing zone 40a is formed. In the preferred embodiment of the present invention, a depth of each of the depressions 50a is between 10 Å and 20 Å. In addition, the laser process is performed in a laser system having a beam attenuator, a beam expander, optic trains, focusing lens, and a pulse laser of an Nd-YVO₄ solid-state laser that involves a light source with a beam of Gaussian profile, i.e. TEM₀₀ mode, and a characteristic wavelength of 1064 nm.

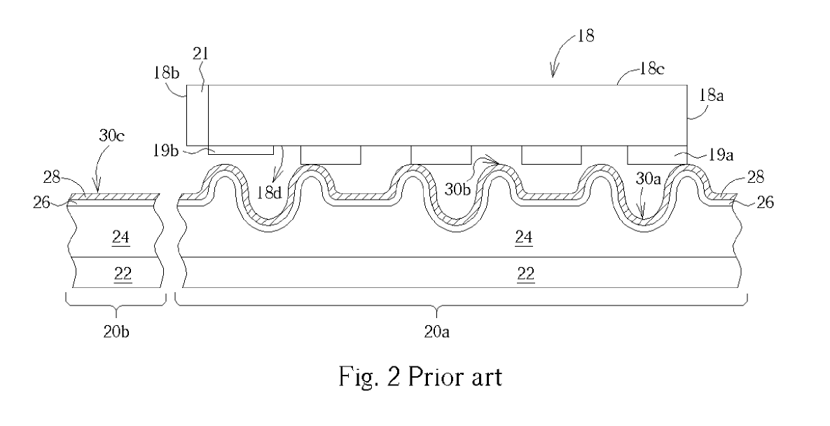

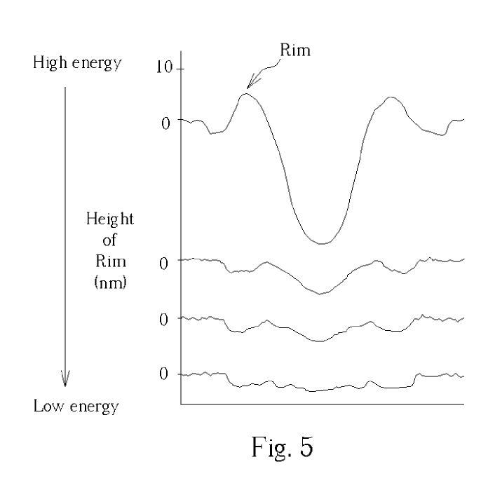

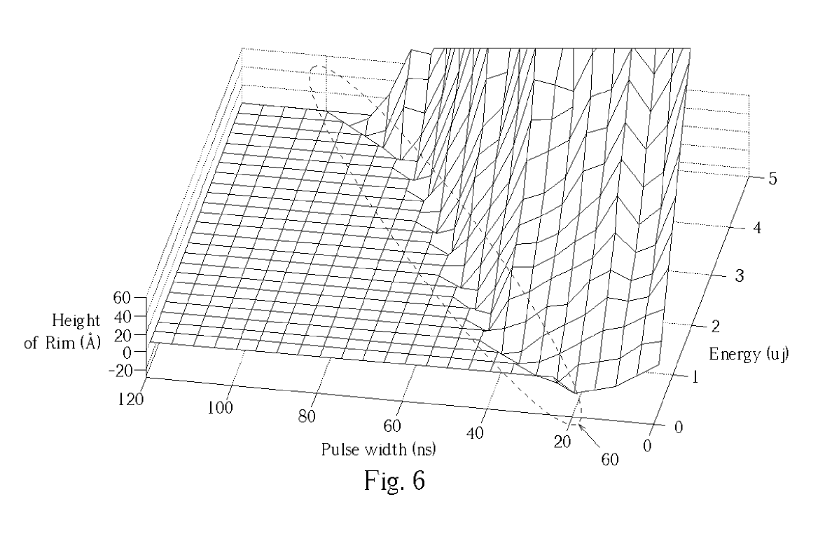

Additionally, it is most important that a pulse width of the pulse laser is preferably between 20 nanoseconds and 90 nanoseconds, and what is more, an energy of the pulse laser is preferably between 0.5 μJ and 6.0 μJ, so that the rimless depression 50a can be formed according to the present invention. Please refer to FIG. 5. FIG. 5 illustrates the relationship between a height of a rim and energy of a pulse laser. As shown in FIG. 5, as the energy of the pulse laser becomes smaller, a height of a rim becomes lower. Furthermore, a depression instead of a rim is formed if the energy of the pulse laser is low enough, so that the present invention utilizes a low energy laser to form the rimless depressions 50a. More specifically, FIG. 6 illustrates the relationship between the pulse width and the energy of the pulse laser for rim height. As shown in FIG. 6, for forming the rimless depressions 50a, the preferred relationship between the pulse width and the energy of the pulse laser is within a region of FIG. 6 marked with an ellipse 60. As long as the laser process is performed under the above-mentioned condition, the rimless depressions 50a can be formed without any rims (or bumps) surrounding them. That is, each of the rimless depressions 50a is not surrounded by an elevated rim but is surrounded by the planar surface 50b, and that is quite different from the prior art disk 20 having a plurality of holes 30a surrounded by rims 30b shown in FIG. 2.

Then, as shown in FIG. 4, a magnetic layer (not shown) for recording the data and an overcoat layer 46 for protecting the magnetic layer are successively sputtered on the nickel-phosphorus plating layer 44. Finally, a lubricant layer 48 is coated over the overcoat layer 46 for reducing the friction/stiction between a slider and a surface of the disk 40. The magnetic layer comprises cobalt(Co), chromium (Cr), a chromium alloy or a cobalt alloy, while the overcoat layer 46 comprises carbon or hydrogenated carbon.

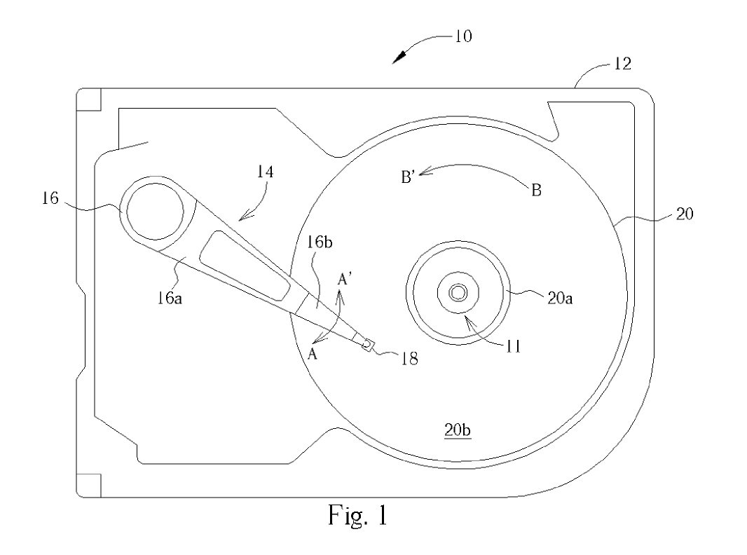

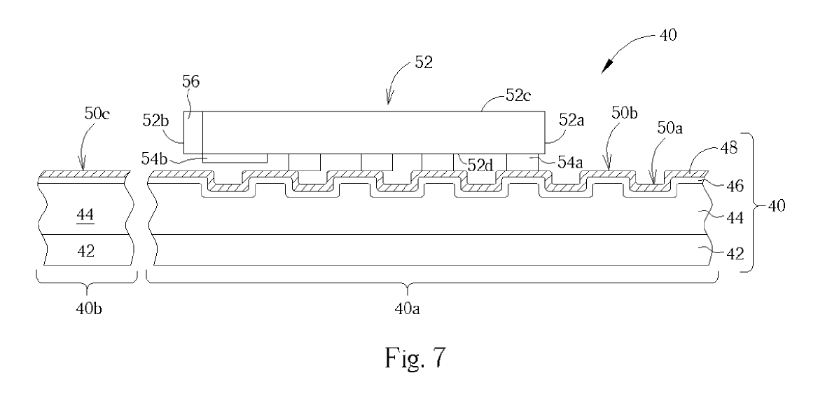

Referring to FIG. 7, FIG. 7 illustrates a disk and a slider parked on a landing zone of the disk according to the present invention. As shown in FIG. 7, the slider 52 formed of a rigid member including a leading edge 52a, a trailing edge 52b, an upper surface 52c, an air bearing surface 52d facing the surface of the disk 40 and having a plurality of pads 54a and a center rail 54b, and a transducer (or magnetic head) 56 for reading or writing operations. Additionally, the slider 52 can be coupled to a suspension assembly of a disk drive, such as the disk drive 10 of FIG. 1, via the upper surface 52c. As is known to those skilled in the art, the slider 52 in FIG. 7 is included for illustration, and it is not intended that the invention be limited to any particular slider design. Any alternative slider design with pads also can be used in the present invention.

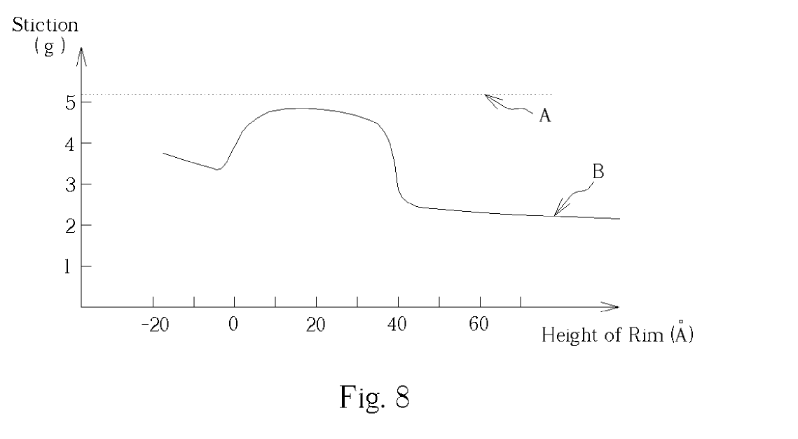

As shown in FIG. 7, because a plurality of rimless depressions 50a is formed in the landing zone 40a, the slider 52 directly contacts with the surfaces 50b as the slider 52 is parked on the landing zone 40a. Thereby, a contact area between the slider 52 and the landing zone 40a is reduced for effectively decreasing the friction/stiction and the tipping issue. Furthermore, FIG. 8 illustrates the relationship between a stiction and a height of a rim. As shown in FIG. 8, the curve A indicates the relationship for a smooth disk, while the curve B represents the relationship for a disk having rims or for a rimless disk. Since the total area of the planar surfaces 50b of a rimless disk in the landing zone is smaller than that of a smooth disk, the stiction of the disk 40 is smaller than that of the smooth disk and is also smaller that that of the conventional disk 20 having a rim height between 0 Å and 40 Å, as shown in FIG. 8.

Additionally, a depth of the depression 50a is so shallow that even though the slider 52 may take away some lubricant from the surfaces 50b, the surfaces 50b always can be supplied with the lubricant from the depressions 50a owing to the surface tension and the capillary phenomenon. Moreover, when the slider 52 flies over the data zone 40b for reading data from or writing data to the disk 40, the slider 52 can fly relatively low since the surfaces 50b of the landing zone 40a are the same level as the surface 50c of the data zone 40b. Accordingly, the capability of the storage density of the disk 40 can be increased and the glide avalanche dimension can be reduced. Due to the rimless depressions 50a, the lubricant layer 48 can be formed with thinner thickness and the head degradation issue of the slider 52 can be prevented effectively. Additionally, because the landing zone 40a doesnt have rims or bumps, the slider 52 is prevented from being worn through repeat impact with the rims or bumps, thereby extending the life of the slider 52 and the disk 40.

In contrast to the prior art, the present invention utilizes the pulse laser with a pulse width of 20˜90 ns and an energy of 0.5˜6.0 μJ to form a plurality of rimless depressions 50a in the landing zone 40a. Due to the rimless depressions 50a, the friction/stiction and the tipping issue are reduced, while the life of the slider 52 and the life the disk 40 are extended. Noticeably, the present invention only utilizes the laser process to make the friction/stiction and the tipping issue be reduced without adding any other techniques, such as a polish process, thereby reducing a production cost. Additionally, since each of the depressions 50a is not surrounded by an elevated rim but is surrounded by the planar surface 50b, the present invention can increase the capability of the storage density of the disk 40 and decrease the glide avalanche dimension. Furthermore, the depressions 50a are so shallow that the surfaces 50b always can be supplied with the lubricant from the depressions 50a for reducing friction/stiction and increasing the wear durability of the surfaces 50b.

More specifically, in contrast to the conventional disk having a rim height between 0 Å and 40 Å, the disk 40 of the present invention has advantages of lowering friction/stiction, less tipping issues, increasing wear durability and the capability of high storage density, decreasing glide avalanche and head degradation, and effectively supplying lubricant. Additionally, in contrast to the conventional smooth disk, the disk 40 of the present invention has advantages of lowering friction/stiction, less tipping issues, increasing wear durability and the capability of high storage density, and effectively supplying lubricant.

Those skilled in the art will readily observe that numerous modifications and alterations of the device may be made while retaining the teachings of the invention. Accordingly, the above disclosure should be construed as limited only by the metes and bound of the appended claims.

1. A method for forming a disk of a disk drive, the disk drive having a slider for reading data from or writing data to the disk, the method comprising:
providing a disk substrate; and
performing a laser process using a pulse laser with a pulse width of 20˜90 ns and an energy of 0.5˜6.0 μJ for forming a plurality of rimless depressions in an inner diameter zone having a radius between 0.65″ and 0.78″ of the disk substrate, so that a landing zone is formed for landing the slider.

2. The method of claim 1 wherein the pulse laser comprises an Nd-YVO₄ solid state laser having a wavelength of 1064 nm.

3. The method of claim 1 wherein the depressions are formed to reduce a contact area between the slider and the landing zone and decrease friction/stiction between the slider and the landing zone.

4. The method of claim 1 wherein the disk substrate comprises a substrate and a plating layer deposited on the substrate.

5. The method of claim 4 wherein the depressions are formed in the plating layer.

6. The method of claim 4 further comprising:
forming a magnetic layer on the plating layer for recording the data;
forming an overcoat layer on the magnetic layer for protecting the magnetic layer; and
coating a lubricant layer over the overcoat layer for reducing friction/stiction of a surface of the disk.

7. The method of claim 6 wherein a depth of each of the depressions is between 10 Å and 20 Å for effectively supplying surfaces of the landing zone with the lubricant from the depressions.

8. The method of claim 6 wherein the substrate comprises an aluminum material.

9. The method of claim 6 wherein the plating layer comprises nickel-phosphorus(NiP).

10. The method of claim 6 wherein the magnetic layer comprises cobalt(Co), a cobalt alloy, chromium (Cr),or a chromium alloy.

11. The method of claim 6 wherein the overcoat layer comprises carbon or hydrogenated carbon.

12. The method of claim 1 wherein the depressions are formed having an approximately uniform size and depth.
